(19) United States
(12) Patent Application Publication
(10) Pub. No.: US 2022/0129039 A1
(43) Pub. Date: Apr. 28, 2022

(54) ELECTRONIC DEVICE HOUSINGS WITH SHOCK ABSORBERS

(71) Applicant: Hewlett-Packard Development Company, L.P., Spring, TX (US)

(72) Inventors: Cheng-Han Tsai, Taipei City (TW); Kuan-Ting Wu, Taipei City (TW); Chong-Wei Wu, Taipei City (TW); Hung-Wei Wu, NanGang Disstrict (TW)

(73) Assignee: Hewlett-Packard Development Company, L.P., Spring, TX (US)

(21) Appl. No.: 17/293,213

(22) PCT Filed: Jul. 11, 2019
(86) PCT No.: PCT/US2019/041272

§ 371 Date: May 12, 2021

(51) Int. Cl. G06F 1/16; B29C 45/14

(52) U.S. Cl. CPC G06F 1/1656; G06F 1/1626; B29K 2705/00; B29C 45/14344; G06F 1/1616

(57) ABSTRACT

In one example, an electronic device housing may include a metal substrate defining an opening and a shock absorber in-mold molded with the metal substrate. Further, shock absorber may include a supporting portion formed on a surface of the metal substrate and a protruding portion that extends from the supporting portion through the opening. Further, the electronic device housing may include a metal layer disposed on the supporting portion.

### BACKGROUND

Metal housings with lightweight and high rigidity properties have become popular since the portable electronic products are developed to be lighter and smaller. In such requirements, metal housings may be manufactured using metal substrates such as magnesium alloy, aluminum alloy, or the like, which may be of low density, high specific strength, good heat dissipation, and anti-electromagnetic interference capability.

### BRIEF DESCRIPTION OF THE DRAWINGS

Examples are described in the following detailed description and in reference to the drawings, in which:

FIG. 1A illustrates a cross-sectional side view of an example electronic device housing, depicting a shock absorber in-mold molded with a metal substrate;

FIG. 1B illustrates the cross-sectional side view of the example electronic device housing of FIG. 1A, depicting additional features;

FIG. 2A illustrates a cross-sectional side view of an example electronic device, depicting a shock absorber in-mold molded with a metal substrate and contacting a display panel;

FIG. 2B illustrates the cross-sectional side view of the example electronic device of FIG. 2A, depicting additional features;

FIG. 3A illustrates an exploded view of an example electronic device housing, depicting a shock absorber including a supporting portion and a set of protruding features;

FIG. 3B is a schematic representation of an example electronic device, depicting the electronic device housing of FIG. 3A to house a display panel; and

FIG. 4 illustrates an example flowchart for manufacturing an electronic device.

### DETAILED DESCRIPTION

Housings for electronic devices such as mobile phones, laptop computers, music players, personal digital assistants, global positioning system devices, and the like can be made by metal. Because of the light weight, metal substrates such as aluminum, aluminum alloy, magnesium, magnesium alloy, or any combination thereof are suitably used in electronic device housings, for instance. In some examples, a housing may include an inner layer including magnesium or magnesium alloy and an outer layer including aluminum or aluminum alloy.

Further, as the electronic devices are becoming compact and portable, the electronic devices may be subjected to various drop events as the electronic devices may be frequently transported. For example, an electronic device may be dropped (e.g., fly from a users hand when a user trips, and/or otherwise fall to the ground or other surface), compressed, bended, or the like. Such drop events may damage glass layers (e.g., a display panel) and/or other electronic components included in the electronic devices. Thus, the electronic devices may be vulnerable to shocks, impacts, and bending stresses. Also, the metal layer or frame, which mounts the electronic components, may support structurally, but offers significantly less protection against damage. Therefore, an ability to protect the electronic devices from external impact and shock is becoming a concerning issue for design considerations in the electronic devices.

Some example methods may provide a significantly stronger display panel to protect the display panel from the external impact. Other example methods may provide different mechanical designs of the housings to protect from the external impact. However, such methods may still be vulnerable to the external impact, and also incur significantly high manufacturing cost.

Examples described herein may provide an electronic device housing with a shock absorber. The electronic device housing may include a metal substrate, a shock absorber in-mold molded with the metal substrate, and a metal layer disposed on the shock absorber. The shock absorber may include a protruding portion that extends from a surface of the metal substrate and contact an underside of a display panel, for instance.

Examples described herein may provide the shock absorber in-mold molded with the electronic device housing to absorb any shocks due to dropping, compressing, bending, or any external impact. Thus, the shock absorber may reduce the failure or damage of display panels or other components of the electronic device from the mechanical shocks and enhance durability of the electronic device.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

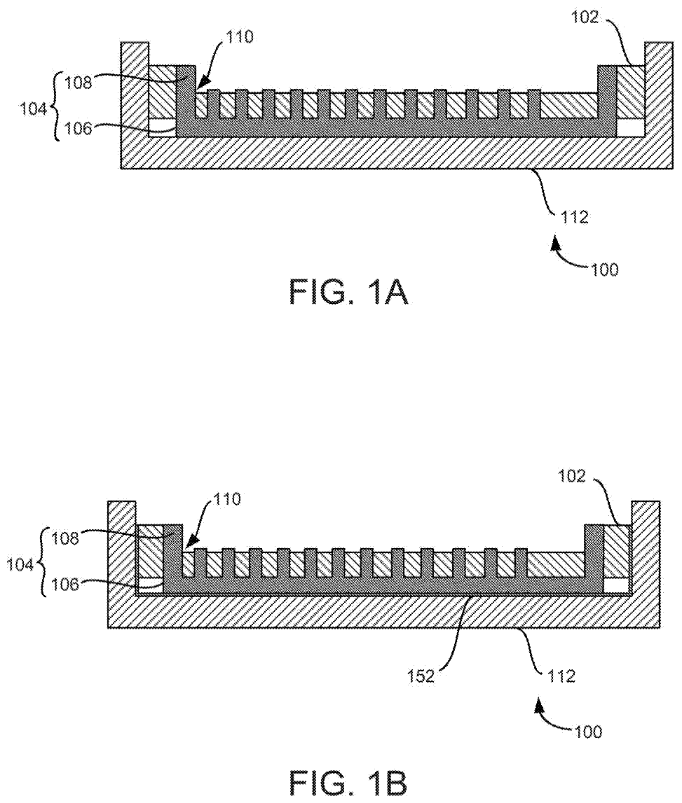

Turning now to the figures, FIG. 1A illustrates a cross-sectional side view of an example electronic device housing 100, depicting a shock absorber 104 in-mold molded with a metal substrate 102. Example electronic device housing 100 may include a smart phone housing, tablet or notebook personal computer housing, digital camera housing, or the like. Further, electronic device housing 100 may be a display housing that houses a display panel, a keyboard housing that houses a keyboard, or a combination thereof. For example, electronic device housing 100 may include the display panel and components such as internal electrical components on printed circuits, mechanical components such as screws, components for facilitating the formation of electrical paths such as hollow tubing, wires, and other structures.

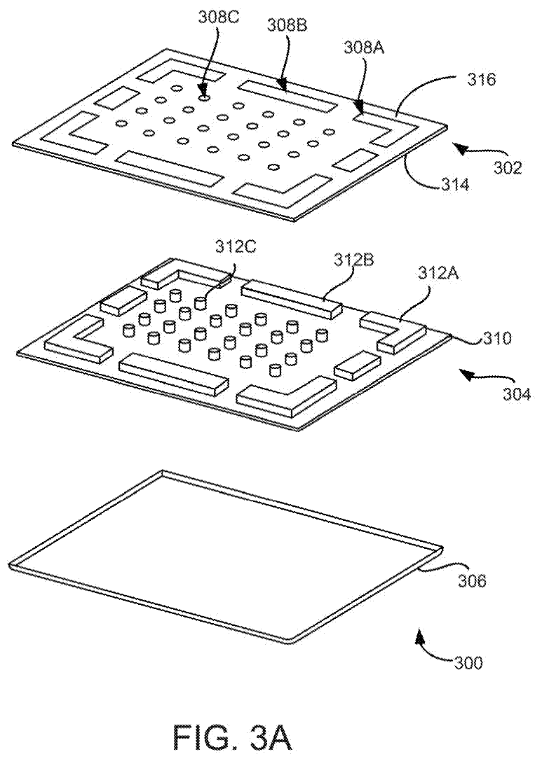

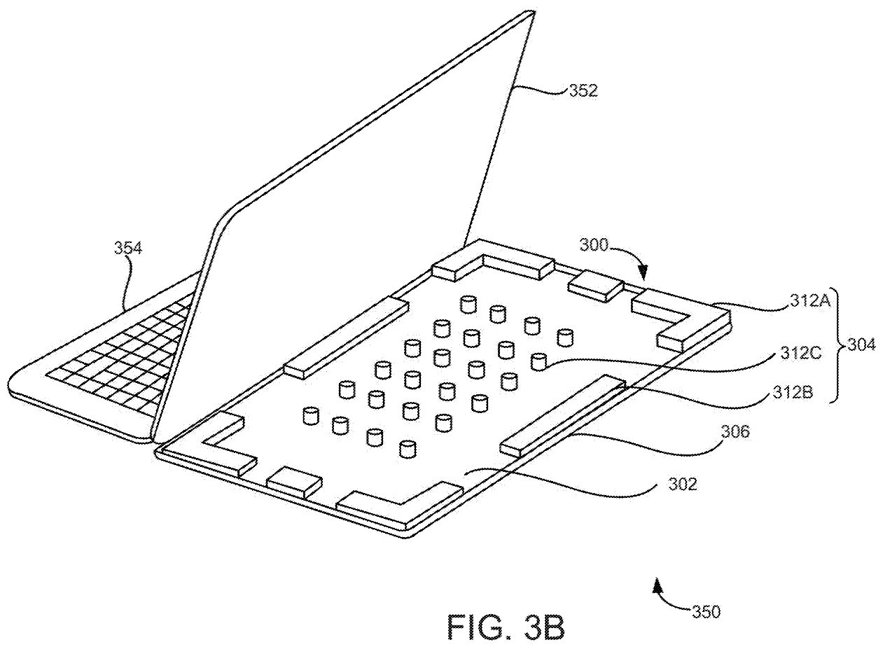

Electronic device housing 100 may include metal substrate 102 defining an opening 110. Example metal substrate 102 may include magnesium, magnesium alloy, or a combination thereof. Example opening 110 is described in FIG. 3A. Further, electronic device housing 100 may include shock absorber 104 in-mold molded with metal substrate 102. In one example, In-mold molding may refer to a process in which metal substrate 102 and shock absorber 104 can be integrally formed into one component via injection molding. Example shock absorber 104 may include thermoplastic urethane, styrenic block copolymers, copolyether ester, polyester amide, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, polysulfide rubber, thermoplastic elastomers, or any combination thereof.

As shown in FIG. 1A, shock absorber 104 may include a supporting portion 106 and a protruding portion 108. In one example, supporting portion 106 may be formed on a surface of metal substrate 102. Further, protruding portion 108 may extend from supporting portion 106 through opening 110.

Further, electronic device housing 100 may include a metal layer 112 disposed on supporting portion 106. Example metal layer 112 may include aluminum, aluminum alloy, or a combination thereof. Thus, shock absorber 104 in-mold molded with metal substrate 102 and coupled to metal layer 112 may provide a cushion function by absorbing stress or shock from external impacts.

FIG. 1B illustrates the cross-sectional side view of example electronic device housing 100 of FIG. 1A, depicting additional features. For example, similarly named elements of FIG. 1B may be similar in structure and/or function to elements described with respect to FIG. 1A. As shown in FIG. 1B, electronic device housing 100 may include an adhesive layer 152 to secure a surface of supporting portion 106 to a surface of metal layer 112. Example adhesive layer 152 may include pressure sensitive adhesive, liquid adhesive, or the like.

In one example, metal substrate 102 may form an inner surface of electronic device housing 100 and metal layer 112 may form an outer surface of electronic device housing 100. Further, electronic device housing 100 can be implemented as a part of a top cover (e.g., the display housing), a bottom cover (e.g., the keyboard housing), or a combination thereof.

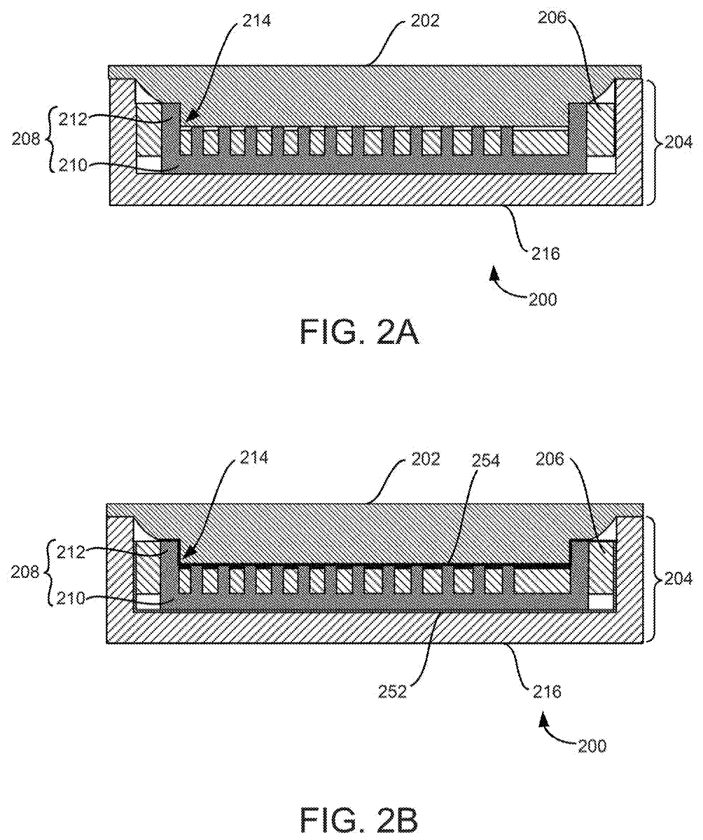

FIG. 2A illustrates a cross-sectional side view of an example electronic device 200, depicting a shock absorber 208 in-mold molded with a metal substrate 206 and contacting a display panel 202. Example electronic device 200 may include display panel 202 and a housing 204 attached to display panel 202. For example, display panel 202 may include a liquid crystal display, an organic light-emitting diode display, a plasma display, an electrophoretic display, a display that is insensitive to touch, a touch sensitive display, or may be any other type of suitable display. Further, electronic device 200 may include a keyboard housing coupled to housing 204 (i.e., a display housing). Example keyboard housing may include components such as keyboard, mousepad, and the like. In one example, the keyboard housing may be rotatably, detachably, or twistably connected to housing 204.

As shown in FIG. 2A, housing 204 may include metal substrate 206 defining an opening 214 (or a set of openings). Further, housing 204 may include shock absorber 208 in-mold molded with metal substrate 206. For example, shock absorber 208 may include thermoplastic urethane, styrenic block copolymers, copolyether ester, polyester amide, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, polysulfide rubber, thermoplastic elastomers, or any combination thereof.

In one example, shock absorber 208 may include a supporting portion 210 and a protruding portion 212. Example supporting portion 210 may be formed on a surface of metal substrate 206 and protruding portion 212 may extend from supporting portion 210 through opening 214 and contacts display panel 202.

Further, housing 204 may include a metal layer 216 disposed on metal substrate 206 via supporting portion 210. Example metal substrate 206 and metal layer 216 may include aluminum, magnesium, lithium, zinc, titanium, aluminum alloy, magnesium alloy, lithium alloy, zinc alloy, titanium alloy, or any combination thereof. Further, metal substrate 206 may include material different from metal layer 216.

FIG. 2B illustrates the cross-sectional side view of example electronic device 200 of FIG. 2A, depicting additional features. For example, similarly named elements of FIG. 2B may be similar in structure and/or function to elements described with respect to FIG. 2A. As shown in FIG. 2B, electronic device 200 may include a first adhesive layer 252 to secure metal layer 216 to metal substrate 206 via supporting portion 210. In other examples, metal layer 216 and metal substrate 206 are bonded together by pressing or rolling.

Further, electronic device 200 may include a second adhesive layer 254 to secure display panel 202 to metal substrate 206 via protruding portion 212. Example first adhesive layer 252 and second adhesive layer 254 may include pressure sensitive adhesive, liquid adhesive, or the like. In other examples, display panel 202, metal substrate 206, and metal layer 216 may also be attached to one another using fasteners such as screws, engagement features (e.g., clips and springs, etc.), magnets, or other suitable attachment mechanisms.

FIG. 3A illustrates an exploded view of an example electronic device housing 300, depicting a shock absorber 304 including a supporting portion 310 and a set of protruding features (e.g., 312A, 312B, and 312C). Example electronic device housing 300 may be a part of a display housing that houses a display, a base housing that houses a keyboard, or any combination thereof. Also, electronic device housing 300 may be part of any other housing that houses and protects a number of internal electronic components.

As shown in FIG. 3A, electronic device housing 300 may include a metal substrate 302, shock absorber 304, and a metal layer 306. In one example, metal substrate 302 may define a set of openings (e.g., 308A, 308B, and 308C). For example, the set of openings may include an opening (e.g., 308A) defined at a corner of metal substrate 302, an opening (e.g., 308B) defined at a side of metal substrate 302, an opening (e.g., 308C) defined in an intermediate region of metal substrate 302, or any combination thereof. Example opening 308A, 308B, or 308C may include a circular opening, an elongated opening, an L-shaped opening, or the like.

Further, shock absorber 304 may include a supporting portion 310 and a set of protruding features (e.g., protruding portions 312A, 312B, and 312C) that extend from supporting portion 310. For example, set of protruding features may include a ring structure 312C in an intermediate region, a square or rectangular structure 312B in a side, and an L-shaped structure 312A in a corner. However, the set of protruding features may include any other shape.

In one example, opening 308A of metal substrate 302 may be defined such that protruding portion 312A of shock absorber 304 may extend from supporting portion 310 through opening 308A and contact a corner of an underside of a display panel of electronic device housing 300.

In one example, the set of protruding features (e.g., protruding portions 312A, 312B, and 312C) of shock absorber 304 may extend from supporting portion 310 through a corresponding one of the set of openings (e.g., 308A, 308B, and 308C) of metal substrate 302 and contact an underside of the display panel at sides, corners, intermediate regions, or any combinations thereof.

As shown in FIG. 3A, supporting portion 310 may be molded onto a first surface 314 of metal substrate 302 such that protruding features 312A, 312B, and 312C may extend beyond a second surface 316 of metal substrate 302 through a corresponding one of openings 308A, 308B, and 308C. Second surface 316 may be opposite to first surface 314. Further, metal layer 306 may be disposed on first surface 314 via supporting portion 310 and a display panel may be disposed on second surface 316 via protruding features 312A, 312B, and 312C.

FIG. 3B is a schematic representation of an example electronic device 350, depicting electronic device housing 300 of FIG. 3A to house a display panel 352. For example, similarly named elements of FIG. 3B may be similar in structure and/or function to elements described with respect to FIG. 3A. Example electronic device 350 may include a keyboard housing 354 and electronic device housing 300 (i.e., a display housing) coupled to keyboard housing 354. Example keyboard housing 354 may include components such as keyboard, mousepad, and the like. In one example, keyboard housing 354 may be rotatably, detachably, or twistably connected to electronic device housing 300.

In one example, electronic device housing 300 may include metal substrate 302, shock absorber 304, and a metal layer 306 as described in FIG. 3A. Further, metal substrate 302 may form an inner surface of electronic device housing 300 and metal layer 306 may form an outer surface of electronic device housing 300.

In one example, electronic device housing 300 may include an adhesive layer to secure display panel 352 to electronic device housing 300 via the set of protruding features (e.g., protruding portions 312A, 312B, and 312C). For example, the set of protruding features may contact an underside of display panel 352 at sides (e.g., using protruding portion 312B), corners (e.g., using protruding portion 312A), intermediate regions (e.g., using protruding portion 312C), or any combinations thereof.

Examples described herein may provide electronic device 350 including shock absorber 304, which can absorb the stress or shock due to external impact. Thus, shock absorber 304 can manage the stress on electronic device housing 300 (e.g., on display panel 352) and may reduce the display panel failure rate from mechanical stress, for instance. Also, shock absorber 304 can absorb strike during assembling, which may increase electronic device production yield rate.

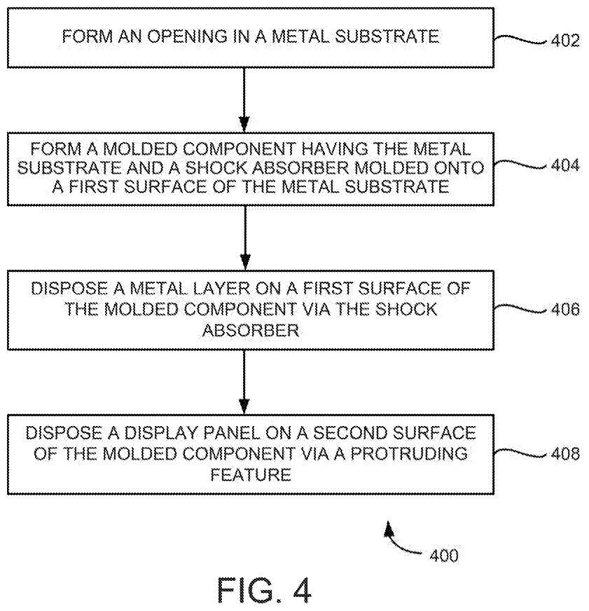

FIG. 4 illustrates an example flowchart 400 for manufacturing an electronic device. It should be understood that example flowchart 400 represents generalized illustrations, and that other processes may be added, or existing processes may be removed, modified, or rearranged without departing from the scope and spirit of the present application. Further, example flowchart 400 may not intended to limit the implementation of the present application, but rather example flowchart 400 illustrates functional information to design/fabricate circuits, generate machine-readable instructions, or use a combination of hardware and machine-readable instructions to perform the illustrated processes.

At 402, an opening may be formed in a metal substrate. At 404, a molded component having the metal substrate and a shock absorber molded onto a first surface of the metal substrate may be formed. In one example, the shock absorber may include a protruding feature extending beyond a second surface of the metal substrate through the opening. Example second surface may be opposite to the first surface. In one example, the molded component having the metal substrate and the shock absorber molded onto the first surface of the metal substrate may be formed via an in-mold molding process. The term “in-mold molding process” may refer to a process in which the metal substrate and the shock absorber can be integrated by means of injection molding. According to the in-mold molding process, a metallic part (e.g., the metal substrate) may be set in a metallic mold, resin (e.g., shock absorber material) can be injected into the metallic mold, and then cured so as to integrate the metallic part with the resin. Thus, in-mold molding process may provide an enhanced bonding between the metal substrate and the shock absorber. In alternate examples, the metal substrate and the shock absorber can be integrated via insert molding.

In one example, the opening may be formed in the metal substrate such that the protruding feature is to contact a corner of an underside of the display panel, a side of the underside of the display panel, an intermediate region of the underside of the display panel, or a combination thereof. In one example, the shock absorber may include a supporting portion formed on the first surface of the metal substrate and the protruding feature extending from the supporting portion through the opening. In other examples, the supporting portion may be molded or integrally formed on the second surface of the metal substrate and include the protruding feature to contact the underside of the display. The supporting portion can be a continuous layer or a discrete layer. In alternate examples, the protruding feature can be directly molded to a surface of the metal substrate via the in-mold molding process.

At 406, a metal layer may be disposed on a first surface of the molded component via the shock absorber. At 408, a display panel may be disposed on a second surface of the molded component via the protruding feature. Thus, the method may allow the use of material whose properties are suitable as the base material (i.e., the metal substrate) for the formation of, for example, a casing for an electronics device, which can be attractive for their strength and light weight, by also providing the metal layer coating that can be treated to provide visual, tactile and textural properties.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An electronic device housing comprising:
a metal substrate defining an opening;
a shock absorber in-mold molded with the metal substrate, wherein the shock absorber comprises:
a supporting portion formed on a surface of the metal substrate; and
a protruding portion that extends from the supporting portion through the opening; and
a metal layer disposed on the supporting portion.

2. The electronic device housing of claim 1, wherein the metal substrate comprises magnesium, magnesium alloy, or a combination thereof.

3. The electronic device housing of claim 1, wherein the metal layer comprises aluminum, aluminum alloy, or a combination thereof.

4. The electronic device housing of claim 1, wherein the shock absorber comprises thermoplastic urethane, styrenic block copolymers, copolyether ester, polyester amide, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, polysulfide rubber, thermoplastic elastomers, or any combination thereof.

5. The electronic device housing of claim 1, further comprising:
an adhesive layer to secure a surface of the supporting portion to a surface of the metal layer.

6. The electronic device housing of claim 1, wherein the metal substrate forms an inner surface of the electronic device housing and the metal layer forms an outer surface of the electronic device housing.

7. An electronic device comprising:
a display panel; and
a housing attached to the display panel, wherein the housing comprises:
a metal substrate defining an opening;
a shock absorber in-mold molded with the metal substrate, wherein the shock absorber comprises:
a supporting portion formed on a surface of the metal substrate; and
a protruding portion that extends from the supporting portion through the opening and contacts the display panel; and
a metal layer disposed on the metal substrate via the supporting portion, wherein the metal substrate comprises material different from the metal layer.

8. The electronic device of claim 7, wherein the metal substrate and the metal layer comprise aluminum, magnesium, lithium, zinc, titanium, aluminum alloy, magnesium alloy, lithium alloy, zinc alloy, titanium alloy, or any combination thereof.

9. The electronic device of claim 7, wherein the shock absorber comprises thermoplastic urethane, styrenic block copolymers, copolyether ester, polyester amide, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, polysulfide rubber, thermoplastic elastomers, or any combination thereof.

10. The electronic device of claim 7, wherein the opening is defined at a corner of the metal substrate such that the protruding portion extends from the supporting portion through the opening and contacts a corner of an underside of the display panel.

11. The electronic device of claim 7, wherein the metal substrate comprises a set of openings including the opening, and wherein the shock absorber comprises a set of protruding features that extend from the supporting portion through a corresponding one of the set of openings and contact an underside of the display panel at sides, corners, intermediate regions, or any combinations thereof.

12. The electronic device of claim 7, wherein the housing further comprises:
a first adhesive layer to secure the metal layer to the metal substrate via the supporting portion; and
a second adhesive layer to secure the display panel to the metal substrate via the protruding portion.

13. A method for manufacturing an electronic device comprising:
forming an opening in a metal substrate;
forming a molded component having the metal substrate and a shock absorber molded onto a first surface of the metal substrate, wherein the shock absorber comprises a protruding feature extending beyond a second surface of the metal substrate through the opening, and wherein the second surface is opposite to the first surface;
disposing a metal layer on a first surface of the molded component via the shock absorber; and
disposing a display panel on a second surface of the molded component via the protruding feature.

14. The method for manufacturing the electronic device of claim 13, wherein forming the opening in the metal substrate comprises:
forming the opening in the metal substrate such that the protruding feature is to contact a corner of an underside of the display panel, a side of the underside of the display panel, an intermediate region of the underside of the display panel, or a combination thereof.

15. The method for manufacturing the electronic device of claim 13, wherein the molded component having the metal substrate and the shock absorber molded onto the first surface of the metal substrate is formed via an in-mold molding process.
